(19) United States
(12) Patent Application Publication
(10) Pub. No.: US 2013/0222314 A1
(43) Pub. Date: Aug. 29, 2013

(54) TOUCH-SENSITIVE DEVICE AND TOUCH-SENSITIVE DISPLAY DEVICE

(71) Applicant: Wintek Corporation, (US)

(72) Inventors: Wen-Chung WANG, Taichung City (TW); Ming-Kung WU, Taichung City (TW); Chia-Chi CHEN, Taichung County (TW); Chih-Jung TENG, Taichung City (TW); Chin-Chang LIU, Fengyuan City, Taichung County (TW); Fa-Chen WU, Taichung City (TW)

(73) Assignee: Wintek Corporation, Taichung City (TW)

(21) Appl. No.: 13/848,608

(22) Filed: Mar. 21, 2013

Related U.S. Application Data
(63) Continuation of application No. 13/756,091, filed on Jan. 31, 2013.
Application No. 13/756,091 is a continuation-in-part of application No. 13/117,954, filed on May 27, 2011.

(30) Foreign Application Priority Data
May 31, 2010 (TW) 099117358
May 18, 2011 (TW) 100117320

(51) Int. Cl. G06F 3/041

(52) U.S. Cl. CPC G06F 3/041
USPC 345/173

(57) ABSTRACT

A touch-sensitive device includes a transparent substrate, a touch-sensing structure, a decorative layer, a metal trace layer, a first insulation layer and a second insulation layer. The touch-sensing structure is disposed on the transparent substrate and located in a touch-sensitive region of the touch-sensitive device. The decorative layer is disposed on a non-touch-sensitive region of the touch-sensitive device, and the metal trace layer is disposed on the non-touch-sensitive region. The first insulation layer is disposed on the transparent substrate and covers the touch-sensing structure and the metal trace layer. The second insulation layer is disposed on the transparent substrate and distributed only in the non-touch-sensitive region to provide a distribution area substantially overlapping the metal trace layer.

### CROSS-REFERENCE TO RELATED APPLICATIONS

This application is a Continuation of co-pending application Ser. No. 13/117,954, filed on May 27, 2011, and for which priority is claimed under 35 U.S.C. §120; and this application claims priority of Application No. 100117320 filed in Taiwan on May 18, 2011; and Application No. 099117358 filed in Taiwan on May 31, 2010, under 35 U.S.C. §119, the entire contents of all of which are hereby incorporated by reference.

### BACKGROUND OF THE INVENTION

a. Field of the Invention

The invention relates to a touch-sensitive device.

b. Description of the Related Art

Referring to FIG. 1, a conventional touch panel 100 has a glass substrate 102, a silicide layer 104 formed on the glass substrate 192, a plurality of touch-sensing electrodes (such as first transparent electrodes 106a and second transparent electrodes 106b), a metal trace layer 108, a dielectric layer 110 and a decorative layer 112. The first transparent electrodes 106a and the second transparent electrodes 106b may be arranged in two directions perpendicular to each other. The first transparent electrodes 106a and the second transparent electrodes 106b are insulated from each other by a dielectric layer 110, and, as shown in FIG. 1, two adjacent second transparent electrodes 106b are connected with each other by a conductive pad 114. The metal trace layer 108 includes a plurality of metal traces, and the silicide layer 116 covers the first transparent electrodes 106a, the second transparent electrodes 106b and the metal trace layer 108 entirely to function as a passivation layer.

The thickness of the silicide layer 116 should be thick enough to protect the component of the touch panel 100. However, a greater thickness of the silicide layer 16 would decrease the transparency of the touch panel 100 in a touch-sensitive region and increase the fabrication costs and time. In contrast, a smaller thickness of the silicide layer 116 designed for reducing fabrication costs and time fails to effectively prevent moisture and protect metal traces, and a side edge of the touch panel 100 is liable to be scraped to reduce production yields and reliability.

### BRIEF SUMMARY OF THE INVENTION

The invention provides a touch-sensitive device having high production yields and low fabrication costs.

In order to achieve one or a portion of or all of the objects or other objects, one embodiment of the invention provides a touch-sensitive device having a touch-sensitive region and a non-touch-sensitive region and including a transparent substrate, a touch-sensing structure, a decorative layer, a metal trace layer, a first insulation layer and a second insulation layer. The touch-sensing structure is disposed on the transparent substrate and located in the touch-sensitive region. The touch-sensing structure includes a plurality of first sensing series and a plurality of second sensing series. The decorative layer is disposed on the non-touch-sensitive region, and the metal trace layer is disposed on the non-touch-sensitive region. The first insulation layer is disposed on the transparent substrate and covers at least the touch-sensing structure and the metal trace layer. The second insulation layer is disposed on the transparent substrate and distributed only in the non-touch-sensitive region to provide a distribution area of the second insulation layer substantially overlapping the metal trace layer.

In one embodiment, the thickness of the second insulation layer may be 3-100 times greater than the thickness of the first insulation layer, and the thickness of the second insulation layer is preferably 10-50 times greater than the thickness of the first insulation layer.

In one embodiment, a first buffer layer is formed on the transparent substrate and covering the transparent substrate, the decorative layer is formed on the first buffer layer, and the metal trace layer is formed on the decorative layer. The second insulation layer is formed on the first insulation layer or formed between the first insulation layer and the metal trace layer.

In one embodiment, the metal trace layer is formed on the first buffer layer, and the second insulation layer is formed on the first insulation layer or formed between the first insulation layer and the metal trace layer.

In one embodiment, each of the first sensing series includes a plurality of first transparent electrodes connected with each other by a plurality first connecting lines, each of the second sensing series includes a plurality of second transparent electrodes connected with each other by a plurality of second connecting lines, the second connecting lines are formed in a fabrication process different to the fabrication process of the first connecting lines, the first transparent electrodes and the second transparent electrodes, and a dielectric layer is disposed between the corresponding first connecting line and second connecting line.

In one embodiment, the second connecting lines are disposed between the first buffer layer and the dielectric layer or between the dielectric layer and the first insulation layer.

In one embodiment, a transparent conductive layer is disposed on the decorative layer and electrically connected to a metal trace layer and an external circuit.

In one embodiment, the material of the decorative layer comprises at least one of diamond-like carbon, ceramic, colored ink, resin and photo resist.

In one embodiment, the second insulation layer surrounds one side of the decorative layer.

In one embodiment, the transparent substrate is a glass substrate or a plastic substrate, the first insulation layer may be made from an inorganic material, the second insulation layer may be made from an inorganic material or an organic material, and the first buffer layer and the second buffer layer may be made from an inorganic material.

According to the above embodiments, since the second insulation layer is additionally provided in the non-touch-sensitive region, the insulating thickness for the periphery of the touch-sensitive device is considerably increased, without changing fabrication processes of a touch-sensing structure in the touch-sensitive region. Moreover, the second insulation layer effectively provides moisture isolation, protects metal traces, and avoids side scrapes to improve production yields and reliability. Besides, the distribution of the second insulation layer is far smaller than that of the first insulation layer to reduce fabrication costs and time.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

FIG. 1 shows a cross-sectional schematic diagram of a conventional touch panel.

FIG. 2A shows a plan view of a touch-sensitive device according to an embodiment of the invention, and FIG. 2B shows an enlarged cross-section of FIG. 2A.

FIG. 3 shows a cross-sectional schematic diagram of a touch-sensitive device according to another embodiment of the invention.

FIG. 4 shows a cross-sectional schematic diagram of a touch-sensitive device according to another embodiment of the invention.

FIG. 5 shows a cross-sectional schematic diagram of as touch-sensitive device according to another embodiment of the invention.

FIG. 6 shows a cross-sectional schematic diagram of a touch-sensitive device according to another embodiment of the invention.

FIG. 7 shows a cross-sectional schematic diagram of a touch-sensitive device according to another embodiment of the invention.

FIG. 8 shows a cross-sectional schematic diagram of a touch-sensitive device according to another embodiment of the invention.

FIG. 9 shows a cross-sectional schematic diagram of a touch-sensitive device according to another embodiment of the invention.

FIG. 10 shows a cross-sectional schematic diagram illustrating a touch-sensitive device in combination with a display device according to an embodiment of the invention.

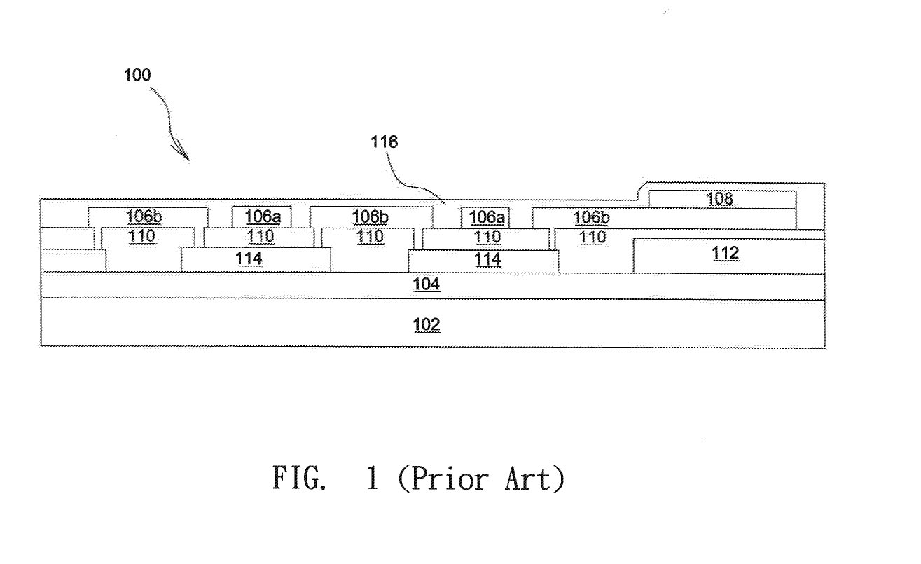

### DETAILED DESCRIPTION OF THE INVENTION

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including,” “comprising.” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

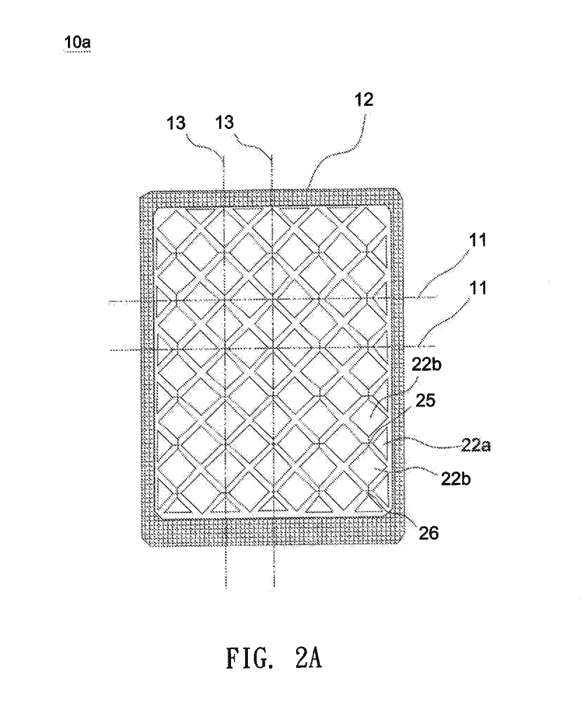

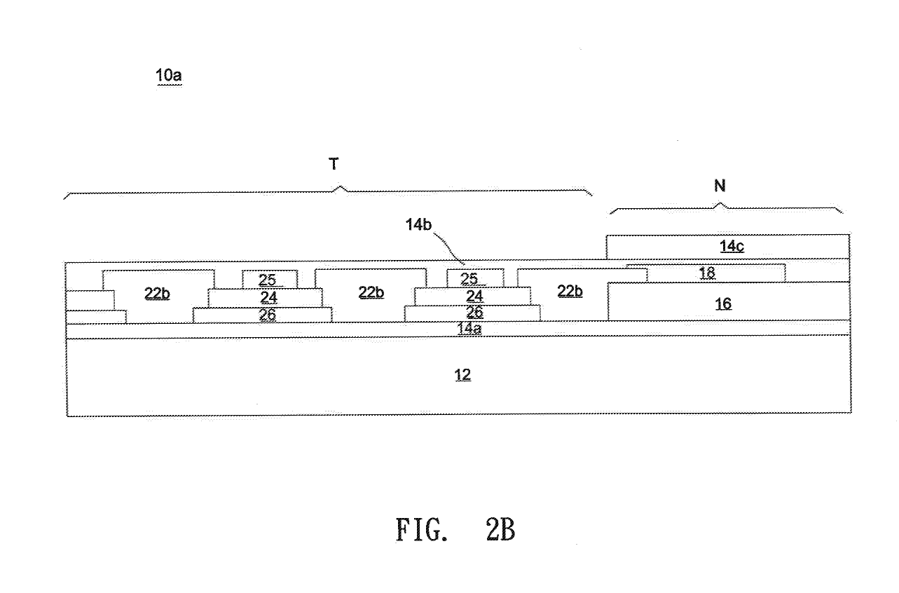

FIG. 2A shows a plan view of a touch-sensitive device according, to an embodiment of the invention, and FIG. 2B shows an enlarged cross-section of FIG. 2A. As shown in FIG. 2A and FIG. 2B, a touch-sensitive device 10a includes a transparent substrate 12 and a laminated structure formed on the transparent substrate 12. The touch-sensitive device 10a is divided into a touch-sensitive region T and a non-touch-sensitive region N. In this embodiment, the non-touch-sensitive region N is located on the periphery of the touch-sensitive device 10a and surrounds the touch-sensitive region T. A touch-sensing structure is substantially formed in the touch-sensitive region T of the touch-sensitive device 10a to detect touch operations. The laminated structure in the non-touch-sensitive region N includes a first buffer layer 14a, a decorative layer 16 and a metal trace layer 18. The first buffer layer 14a may be formed on and cover the transparent substrate 12, and the decorative layer 16 and the metal trace layer 18 are disposed on the transparent substrate 12 in succession. The material of the transparent substrate 12 includes but not limited to glass or plastic. Further, the transparent substrate 12 may function as a cover lens. The metal trace layer 18 includes a plurality of metal traces, and a touch-sensing structure in the touch-sensitive region T is connected to an external circuit through the metal traces. The decorative layer 16 is formed on the periphery of the transparent substrate 12 to shield metal traces. The material of the decorative layer 16 includes diamond-like carbon, ceramic, colored ink, resin, photo resist or the combination thereof. The touch-sensing structure in the touch-sensitive region T may be a single-layer electrode structure or a multi-layer electrode structure. In the present embodiment, the touch-sensing structure may include a plurality of first sensing series 11 and a plurality of second sensing series 13 spaced apart from the first sensing series 11. For example, as shown in FIG. 2B, the touch-sensing structure has an underground-island electrode structure, where each first sensing series 11 includes multiple first transparent electrodes 22a connected with each other by multiple first connecting lines 25, each second sensing, series 13 includes multiple second transparent electrodes 22b connected with each other by multiple second connecting lines 26, and a dielectric layer 24 is disposed between the corresponding first connecting line 25 and second connecting line 26. The second connecting lines 26 are formed in a fabrication process different to the fabrication process of the first connecting lines 25, the first transparent electrodes 22a and the second transparent electrodes 22b. Besides, the second connecting lines 26 may be disposed between the dielectric layer 24 and first buffer layer 14a. Note the touch-sensing structure is not limited to an underground-island electrode structure. In an alternate embodiment, the connecting lines are connected with each other in the upper portion of the touch-sensing structure to form a bridge-island electrode structure. Further, the touch-sensing structure may be disposed on two opposite sides of the transparent substrate 12, and the transparent electrodes may have a regular shape such as a diamond, a triangle or a line segment or may have an irregular shape.

Further, the first buffer layer 14a is an auxiliary layer used to enhance the adherence between the transparent substrate 12 and the first transparent electrodes 22a, the second transparent electrodes 22b and the second connecting lines 26. Certainly, the first buffer layer 14a may be omitted, in other embodiments. In this embodiment, the first buffer layer 14a may be made from an inorganic material such as silicon dioxide (SiO₂).

In this embodiment, a first insulation layer 14b covers both a touch-sensing structure in the touch-sensitive region T and a laminated structure in the non-touch-sensitive region N to protect the entire touch-sensitive device 10a. The first insulation layer 14b may be made from an inorganic material such as silicide. ID this embodiment, a second insulation layer 14c is formed on the first insulation layer 14b and distributed only in the non-touch-sensitive region N, and the thickness of the second insulation layer 14c is 3-100 times greater than the thickness of the first insulation layer 14b. A distribution area of the second insulation layer 14c substantially overlaps the metal trace layer 18, and the thickness of the second insulation layer 14c is, in a preferred embodiment, 10-50 times greater than the thickness of the first insulation layer 14b. The second insulation layer 14c may be made from an inorganic material or an organic material. Further, in an alternate embodiment, the second insulation layer 14c may be disposed between the metal trace layer 18 and the decorative layer 16 or between the decorative layer 16 and the first buffer layer 14a, as long as the second insulation layer 14c is confined in the non-touch-sensitive region N.

According to the above embodiments, since the second insulation layer 14c is additionally provided in the non-touch-sensitive region N, the insulating thickness for the periphery of the touch-sensitive device 10a is considerably increased without changing fabrication processes of a touch-sensing structure in the touch-sensitive region 1′. Moreover, the second insulation layer 14c effectively provides moisture isolation, protects metal traces, and avoids side scrapes to improve production yields and reliability. Besides, the distribution of the second insulation layer 14c is far smaller than that of the first insulation layer 14b to reduce fabrication costs and time.

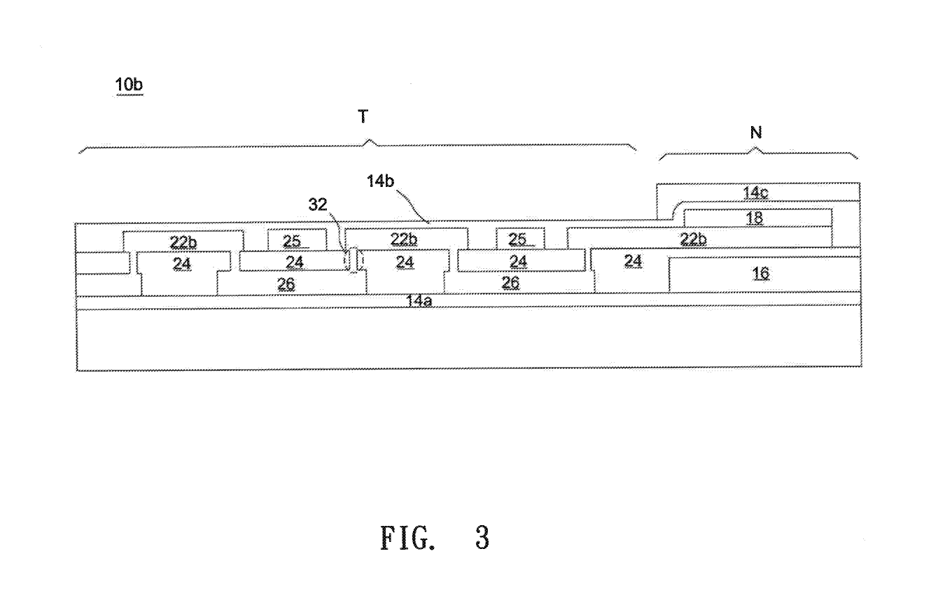

FIG. 3 shows a cross-sectional schematic diagram of a touch-sensitive device 10b according to another embodiment of the invention. Referring to FIG. 3, a laminated structure in the non-touch-sensitive region N of the touch-sensitive device 10b is similar to the laminated structure shown in FIG. 2B, but a touch-sensing structure in the touch-sensitive region T is different to the touch-sensing structure shown in FIG. 2B. The touch-sensing structure shown in FIG. 3 has an underground-via electrode structure, where each second connecting line 26 is connected to two adjacent second transparent electrodes through a via 32, and the first insulation layer 14b covers the first transparent electrodes 22a, the second transparent electrodes 22b and the first, connecting lines 25.

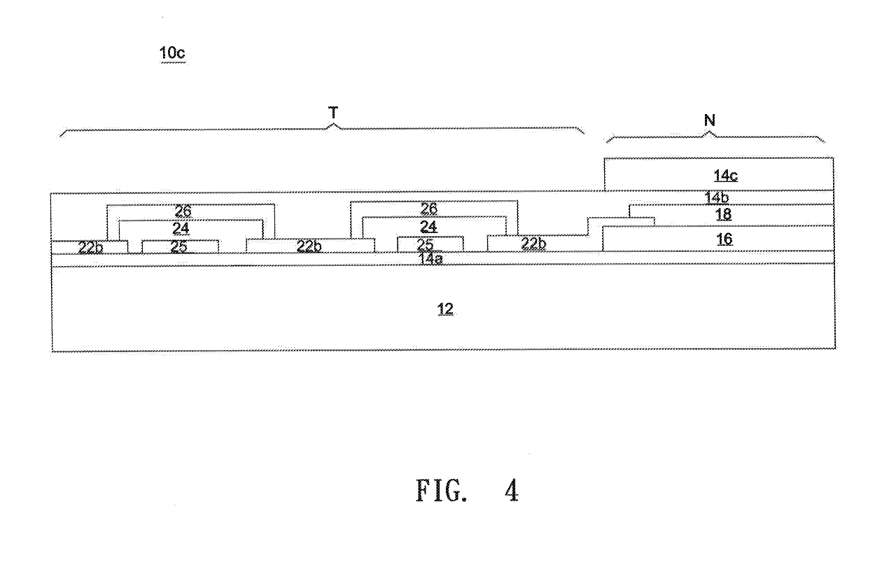

FIG. 4 shows a cross-sectional schematic diagram of a touch-sensitive device 10c according to another embodiment of the invention. Referring, to FIG. 4, a laminated structure in the non-touch-sensitive region N of the touch-sensitive device 10c is similar to the laminated structure shown in FIG. 2B, but a touch-sensing structure in the touch-sensitive region T is different to the touch-sensing structure shown in FIG. 2B. The touch-sensing structure shown in FIG. 4 has a bridge-island electrode structure, where each second connecting line 26 is connected to two adjacent second transparent electrodes 22b. The first transparent electrodes 22a and the second transparent electrodes 22b are spaced apart through the dielectric layer 24, and the first insulation layer 14b covers the first transparent electrodes 22a, the second transparent electrodes 22b and the second connecting lines 26. That is, the second connecting lines 26 are disposed between the dielectric layer 24 and the first insulation layer 14b.

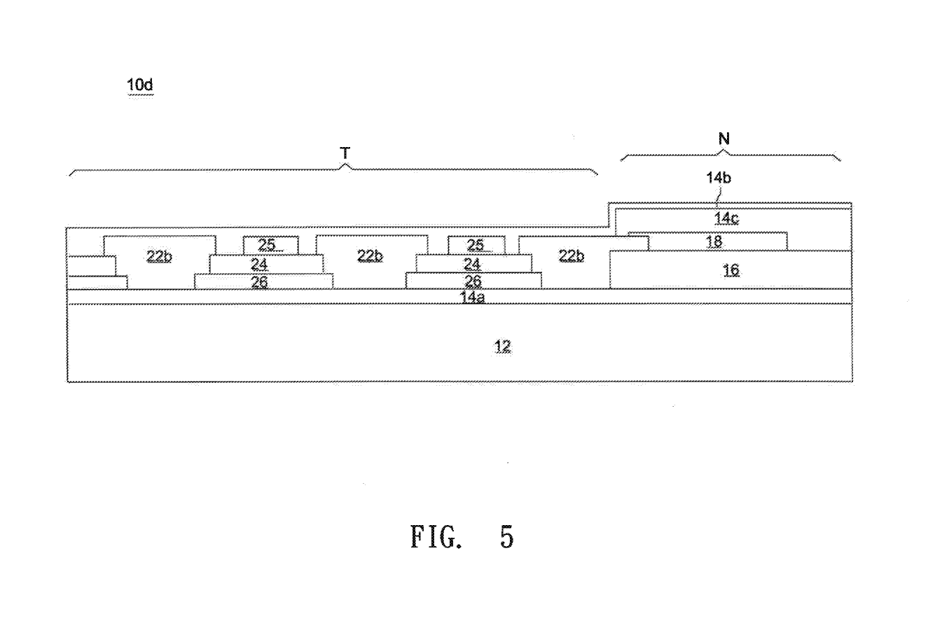

FIG. 5 shows a cross-sectional schematic diagram of a touch-sensitive device 10d according to another embodiment of the invention. Referring to FIG. 5, a touch-sensing structure in the touch-sensitive region T of the touch-sensitive device 10d is similar to the touch-sensing structure shown in FIG. 2B, but a laminated structure in the non-touch-sensitive region N of the touch-sensitive device 10d is different to the laminated structure shown in FIG. 2B. In this embodiment, the second insulation layer 14c is disposed between the metal trace layer 18 and the first insulation layer 14b to similarly provide moisture isolation, protect metal traces, and avoid side scrapes to improve production yields and reliability. Certainly, the arrangement that the second insulation layer 14c is disposed between the metal trace layer 18 and the first insulation layer 14b is also suitable for the underground-via electrode structure shown in FIG. 3 or the bridge-island electrode structure shown in FIG. 4.

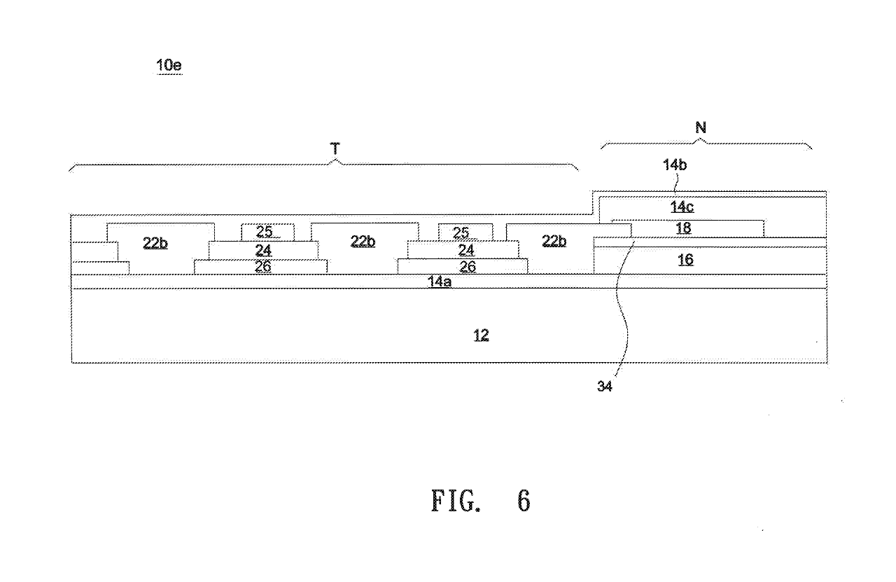

FIG. 6 shows a cross-sectional schematic diagram of a touch-sensitive device 10e according to another embodiment of the invention. Referring to FIG. 6, a touch-sensing structure in the touch-sensitive region T of the touch-sensitive device 10e is similar to the touch-sensing structure shown in FIG. 2B, but a laminated structure in the non-touch-sensitive region N of the touch-sensitive device 10e is different to the laminated structure shown in FIG. 2B. In this embodiment, a second buffer layer 34 is additionally provided between the decorative layer 16 and the metal trace layer 18. The second buffer layer 34 that may be made from an inorganic material such as silicon dioxide (SiO2) may enhance the connection strength between the metal trace layer 18 and the decorative layer 16. Certainly, the arrangement of the second buffer layer 34 is also suitable for the underground-via electrode structure shown in FIG. 3 or the bridge-island electrode structure shown in FIG. 4.

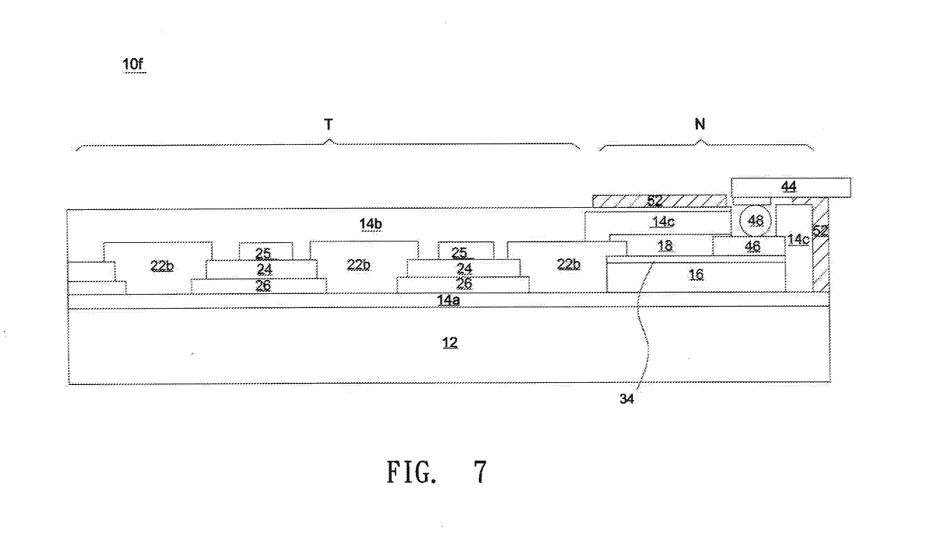

FIG. 7 shows a cross-sectional schematic diagram of a touch-sensitive device 10f according to another embodiment of the invention. In this embodiment, the second insulation layer 14c extends in two directions respectively parallel to and perpendicular to the transparent substrate 12 to surround one side of the decorative layer 16. A transparent conductive layer 46 is formed on the second buffer layer 34 and electrically connected to the metal traces in the metal trace layer 18. The transparent conductive layer 46 may be made from an no transparent conductive film. An opening is formed on the second insulation layer 14c at a position overlapping a bonding area of the transparent conductive layer 46 to expose a part of the transparent conductive layer 46. The exposed part of the transparent conductive layer 46 is electrically connected to an external circuit through an anisotropic conductive film (ACF) 48, and the external circuit may be a transmission device (such as a flexible printed circuit board 44) or an electronic device (such as an IC chip. The transparent conductive layer 46 is not limited to be formed on the second buffer layer 34. For example, in case the second buffer layer 34 is not provided as shown in FIG. 5, the transparent conductive layer 46 may be formed on the decorative layer 16. Besides, an ink layer 52 is disposed on the periphery of the touch-sensitive device 10f to surround the decorative layer 16 on the second insulation layer 14c to provide periphery protection of the wiring, structure an the cover lens and avoid peripheral light leakage.

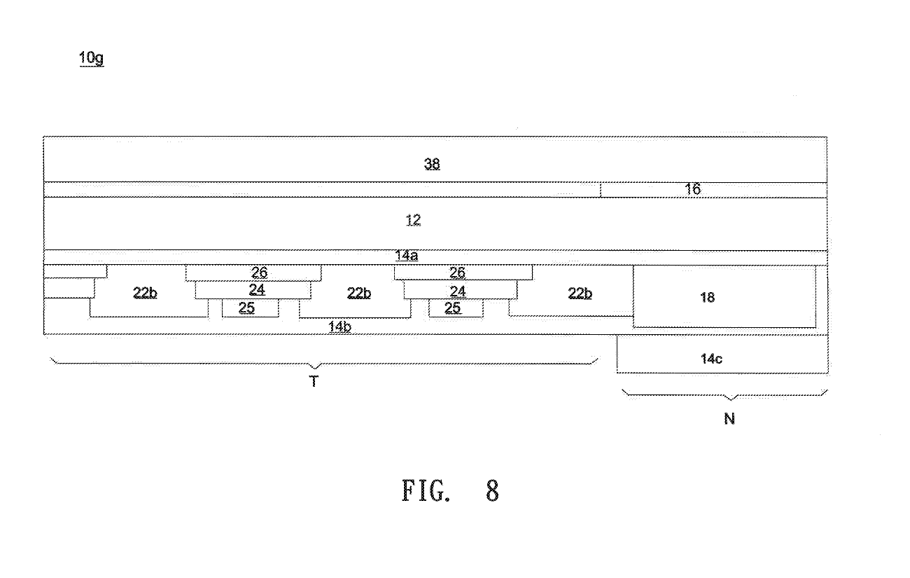

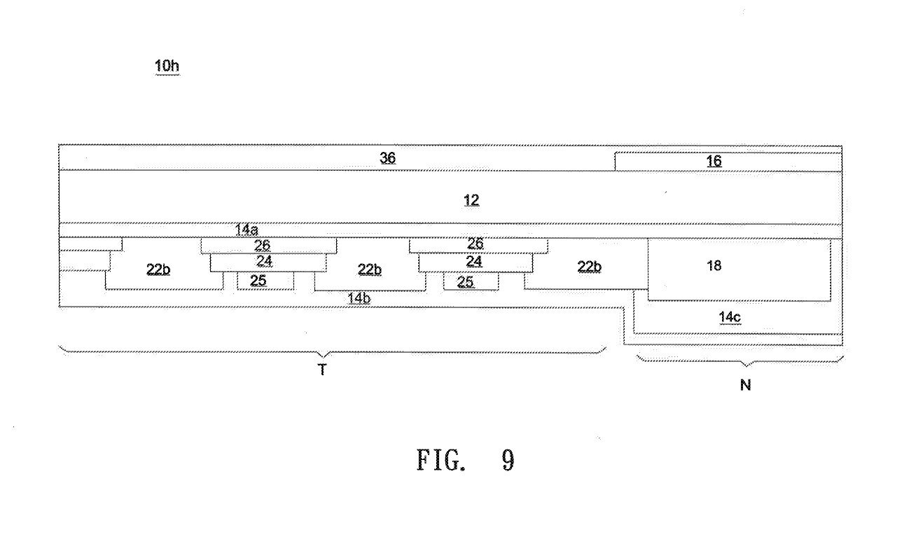

Referring to FIG. 8, a touch-sensitive device 10g includes a cover glass 38. The cover glass 38 is formed on one side of the transparent substrate 12 opposite the metal trace layer 18 and has a decorative layer 16. The decorative layer 16 is formed on one side of the cover glass 38 lacing the transparent substrate 12 to allow the cover glass 38 to serve the function of shielding metal traces and protecting the entire touch-sensitive device log. Alternatively, as shown in FIG. 9, the cover glass 38 in a touch-sensitive device 10h may be omitted, and the decorative layer 16 is directly formed on one side of the transparent substrate 12 opposite the metal trace layer 18. Further, a passivation layer 36 may be formed on the decorative layer 16 to serve protection purposes. The material of the passivation layer 36 includes but not limited to polyethylene terephthalate (PET). In addition, the second insulation layer 14c may be formed on the first insulation layer 14b (FIG. 8) or formed between the first insulation layer 14b and the metal trace layer 18 (FIG. 9).

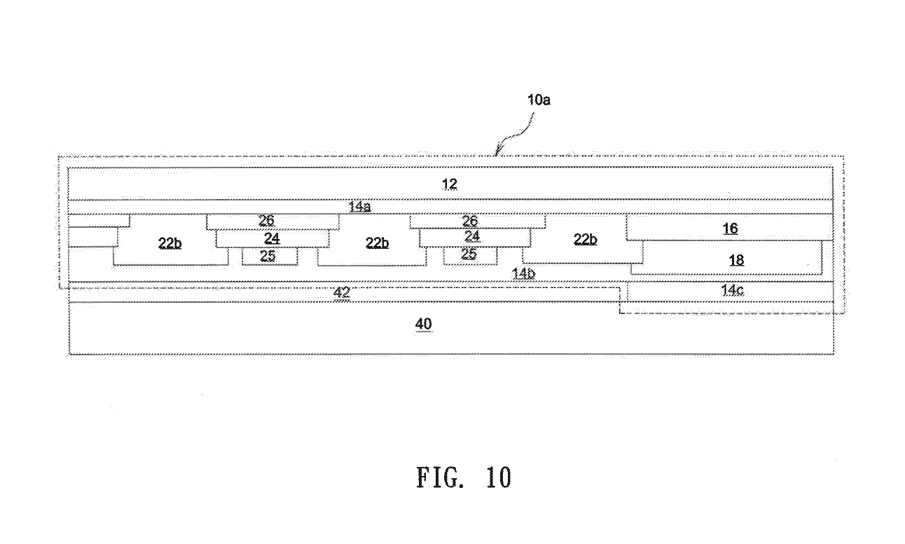

FIG. 10 shows a cross-sectional schematic diagram illustrating a touch-sensitive device in combination with a display device according to an embodiment of the invention. Referring to FIG. 10, the touch-sensitive device 10a is connected to a display device 40 by, for example, an optical adhesive 42. The type of the display device includes but not limited in a liquid crystal display, an organic light-emitting diode display, an electro-wetting display, a bi-stable display, and an electrophoretic display.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided, to comply with the rules requiring an abstract, which will allow searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the present disclosure is intended to be dedicated to the public regardless of whether the element or component is explicitly recited in the following claims.

What is claimed is:

1. A touch-sensitive device, comprising:
a substrate;
a touch-sensing structure disposed on the substrate;
a decorative layer disposed on the substrate;
a trace layer disposed on the decorative layer and electrically connected to the touch-sensing structure;
a first insulation layer disposed on the substrate and covering the touch-sensing structure and the trace layer; and
a second insulation layer disposed on the first insulation layer, wherein the first insulation layer is between the trace layer and the second insulation layer.

2. The touch-sensitive device as claimed in claim 1, wherein the second insulation layer is at least located in a region substantially overlapping the trace layer.

3. The touch-sensitive device as claimed in claim 1, wherein the decorative layer is disposed at least on part of a periphery of the substrate.

4. The touch-sensitive device as claimed in claim 1, wherein the thickness of the second insulation layer is 3-100 times greater than the thickness of the first insulation layer.

5. The touch-sensitive device as claimed in claim 1, wherein the thickness of the second insulation layer is 10-50 times greater than the thickness of the first insulation layer.

6. The touch-sensitive device as claimed in claim 1, further comprising:
a conductive layer disposed on the decorative layer and electrically connected to the trace layer and an external circuit.

7. The touch-sensitive device as claimed in claim 1, further comprising:
a first buffer layer formed on the substrate and covering the substrate, wherein the decorative layer is formed on the first buffer layer and the trace layer is formed on the decorative layer.

8. The touch-sensitive device as claimed in claim 1, further comprising:
a second buffer layer formed between the trace layer and the decorative layer.

9. The touch-sensitive device as claimed in claim 1, wherein a part of the touch-sensing structure is formed on the decorative layer.

10. The touch-sensitive device as claimed in claim 1, wherein the touch-sensing structure comprises a plurality of first sensing series and a plurality of second sensing series, each of the first sensing series comprises a plurality of first electrodes connected with each other by a plurality first connecting lines, each of the second sensing series comprises a plurality of second electrodes connected with each other by a plurality of second connecting lines, and a part of the first electrodes or a part of the second electrodes is formed on the decorative layer.

11. The touch-sensitive device as claimed in claim 1, wherein the substrate is a glass substrate or a plastic substrate.

12. A touch-sensitive device, comprising:
a substrate;
a touch-sensing structure disposed on the substrate;
a trace layer disposed on a periphery of the substrate;
a first insulation layer disposed on the substrate and covering the touch-sensing structure and the trace layer;
a second insulation layer at least disposed on a periphery of the substrate;
a cover glass disposed on one side of the substrate; and
a decorative layer formed on one side of the cover glass.

13. A touch-sensitive display device, comprising:
a touch-sensitive device, comprising:
a substrate;
a touch-sensing structure disposed on the substrate;
a decorative layer disposed on the substrate;
a trace layer disposed on the decorative layer and electrically connected to the touch-sensing structure;
a first insulation layer disposed on the substrate and covering the touch-sensing structure and the trace layer; and
a second insulation layer disposed on the first insulation layer; and
a display device disposed on one side of the touch-sensitive device, wherein the second insulation layer is disposed between the first insulation layer and the display device.

14. The touch-sensitive display device as claimed in claim 13, wherein the second insulation layer is at least located in a region substantially overlapping the trace layer.

15. The touch-sensitive display device as claimed in claim 13, wherein the display device is a liquid crystal display, an organic light-emitting diode display, an electro-wetting display, a bi-stable display, or an electrophoretic display.
